(19) United States
(12) Patent Application Publication
(10) Pub. No.: US 2001/0034652 A1
(43) Pub. Date: Oct. 25, 2001

(54) Content delivering system

(75) Inventors: Takashi Kondo, Sakai-Shi (JP); Masaaki Nakai, Osaka-Shi (JP); Koichi Kohriyama, Amagasaki-Shi (JP); Kazuaki Okumura, Ikeda-Shi (JP); Hideo Hotomi, Nishinomiya-Shi (JP); Katsuhiko Asai, Takatsuki-Shi (JP)

Correspondence Address: SIDLEY AUSTIN BROWN & WOOD, 717 NORTH HARWOOD, SUITE 3400, DALLAS, TX, 75201, US

(73) Assignee: MINOLTA CO., LTD.

(21) Appl. No.: 09/808,239

(22) Filed: Mar. 14, 2001

(30) Foreign Application Priority Data
Mar. 24, 2000 (JP) 2000-084186

(51) Int. Cl. G06F 17/60

(52) U.S. Cl. 705/14

(57) ABSTRACT

A content delivering system comprising a host server for receiving therein a plurality of individual contents and corresponding display conditions; a transit server for receiving and storing the plurality of individual contents; and a plurality of display terminals for receiving and displaying the individual contents delivered from the transit server, wherein the transit server assigns and timely delivers the plurality of individual contents to an appropriate display terminal according to the corresponding display data conditions. Additionally, the display data may be selected based on vacancy data or potential viewership data.

This application is based upon Application No. 2000-84186 filed in Japan, the contents of which are hereby incorporated by reference.

### FIELD OF THE INVENTION

The present invention relates to a content delivering system and, more particularly, to a system for delivering advertisements as primary content to a plurality of display terminals.

### BACKGROUND OF THE INVENTION

Conventionally, advertisements for an indefinite number of customers have been printed on paper. However, in recent years, various paper-like display devices using a liquid crystal or the like, which have a small thickness and a wide display region, have been developed. Advertisement display systems employing display devices of this type have been proposed as a replacement for advertisements using paper.

For example, Japanese Unexamined Patent Publication No. Hei 5-233893 discloses an advertisement system which displays data transmitted from an advertising agency on each of a plurality of display terminals via servers provided in vehicles. In actually using such a system, it becomes necessary to solve the problem of how to assign a variety of advertisements to a large number of display terminals such that they are displayed thereon. In the foregoing publication, however, no solution has been proposed to such a problem. Another problem which remains to be solved is the increased burden on management and communication which results from an increase in the number of display terminals. Yet another burden which would result from the above advertisement display systems would occur due to the added complexity of routing only specific data to some but not all display terminals while simultaneously routing other data to other display terminals. An example of this would occur when an advertiser has numerous advertisements, but wishes to display certain ads on specific displays only, or wishes to cycle the ads and display them only for a period of time in either a specific or random order.

### BRIEF SUMMARY OF THE INVENTION

It is therefore an object of the present invention to provide a content delivering system which allows efficient display and management of a variety of contents on a plurality of display terminals.

Another object of the present invention is to provide a content delivering system capable of reducing a burden on the management and communication of the contents to be displayed in addition to the aforesaid object.

To attain the foregoing objects, a content delivering system in accordance with a first aspect of the invention comprises: a host server for storing therein data comprising a plurality of contents; transit servers for receiving the contents from the host server; and display terminals for receiving the contents delivered from the transit servers. The content delivery system is characterized in that the transit servers assign and deliver individual content of the plurality of contents to specified display terminals.

In the content delivering system in accordance with the first aspect of the invention, each of the individual content is assigned and delivered by the transit servers as starting points to the specified display terminals. This reduces the burden of the communication of the content and thereby allows efficient display of individual content on the individual display terminals.

In the content delivering system in accordance with the first aspect of the invention, in particular, the transit servers preferably receive display conditions accompanying the contents from the host server, judge whether or not the display conditions are satisfied, and deliver the contents to the individual display terminals.

A content delivering system in accordance with the second aspect of the invention comprises: a host server for storing therein data comprising a plurality of contents; transit servers for receiving the contents from the host server; and display terminals for receiving the contents delivered from the transit servers. The content delivery system is characterized in that each of the transit servers transmits, to the display terminals, the contents in conjunction with display conditions indicative of the display terminals corresponding to the individual content. Based upon the display conditions, each of the display terminals effects display of the contents on the display terminal in accordance with the data.

In the content delivering system in accordance with the second aspect of the invention, each of the contents has the display conditions indicative of the corresponding display terminals added thereto and the display terminals to which the content has been delivered effect display in accordance with the display conditions. In other words, each of the display terminals displays the content if the display conditions indicate that it is the content to be displayed thereon and does not display the content if it is not. This reduces a management burden on the transit servers and thereby allows efficient display and routing of a variety of contents.

In the content delivering systems in accordance with the first and second aspects of the invention, the display terminals are preferably divided into a plurality of groups and each of the transit servers preferably delivers the same content to the display terminals belonging to each of the groups. This allows easier management of the delivery of the content.

### BRIEF DESCRIPTION OF THE DRAWINGS

Referring now to the drawings in which like reference numerals and letters indicate corresponding elements throughout the several views, if applicable:

FIG. 1 is a schematic structural view showing a content delivering system according to the first embodiment of the present invention;

FIG. 2 is a schematic structural view showing a content delivering system according to the second embodiment of the present invention;

FIG. 3 is a schematic structural view showing a content delivering system according to the third embodiment of the present invention;

FIG. 4 is a view illustrating an example of display on the screen of a personal computer that has access to a host server;

FIG. 5 is a flow chart showing the processing procedure upon a reception at the host server;

FIG. 6 is a flow chart showing the processing procedure when a determined charge is inputted at the host server,

FIG. 7 is a flow chart showing the processing procedure when a content is inputted to a transit server;

FIG. 8 is a flow chart showing the processing procedure when an update is checked at the transit server; and

FIG. 9 is a flow chart showing the processing procedure when display is updated on a display terminal.

### DETAILED DESCRIPTION OF THE INVENTION

Referring now to the accompanying drawings, the embodiments of a content delivering system according to the present invention will be described.

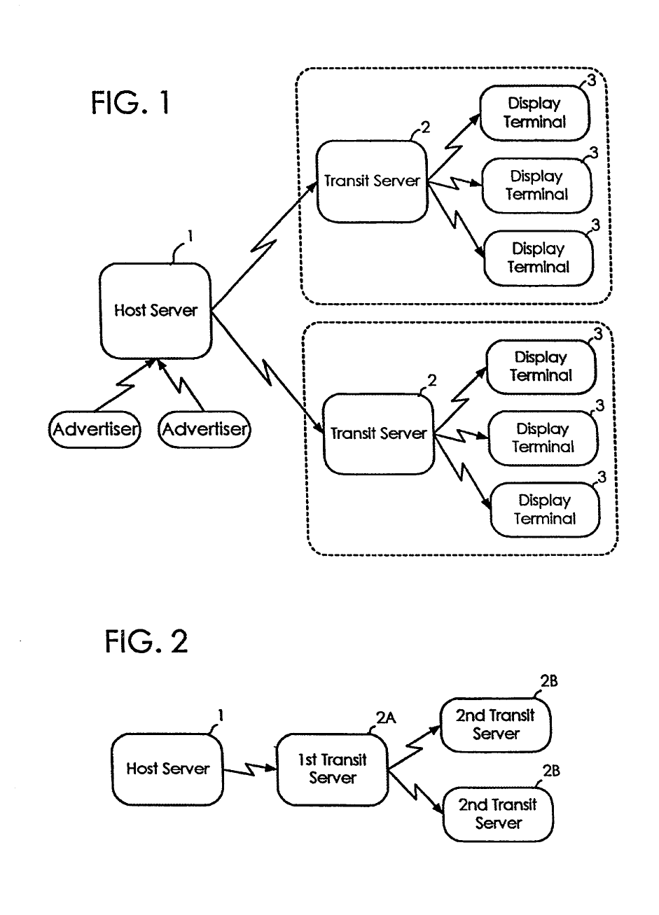

FIG. 1 shows a content delivering system according to the first embodiment, which is generally composed of a host server 1, transit servers 2, and display terminals 3. The host server 1 is installed at an advertising agency or a company as the user of the present system such as an electric railway company to receive advertising contents and publishing conditions therefor from an indefinite number of advertisers via the Internet. The host server 1 adds to the contents the publishing conditions and transfers the content to transit servers 2.

Each of the transit servers 2 comprises a plurality of display terminals 3 and are disposed at different places. For example, the transit servers 2 are disposed at individual buildings, stations, and vehicles in a one-to-one relationship. The transit servers 2 may also be disposed for individual tram lines in a one-to-one relationship and at arbitrary places. Each of the display terminals 3 has an ID which is used during communication with the transit server 2. Each of the transit servers 2 selectively delivers the content transferred from the host server 1 based on the publishing conditions therefor to the display terminals 3 under the control thereof and displays the content on the display terminals 3. The publishing conditions include an advertisement publishing period and an advertisement location. In a vehicle, the advertisement location means a hanging display, a wall mounted display, bulletin board, placard, billboard, or the like. The transit server 2 terminates the display on the display terminals 3 if the publishing period for the content is completed. Since the transit server 2 controls a display schedule for each of the display terminals 3, a management burden on the host server 1 is reduced.

The display terminals 3 may be installed at arbitrary locations including the main entrance, an elevator hall on each floor, or the like, of a building and the hanging or wall mounted display, e.g., a bulletin board, billboard, or placard, of a tram. As a display medium, a TFT liquid crystal, a nematic liquid crystal, a chiral nematic liquid crystal, an LED, a light-emitting (LE) element, or the like, is used. If a display medium having a memory property such as the chiral nematic liquid crystal is used, the display of the content will be maintained even if the supply of electric power is halted, which contributes to energy conservation.

FIG. 2 shows a principal portion of a content delivering system as the second embodiment, in which the transit server 2 shown in FIG. 1 has a two-level configuration consisting of first and second transit servers 2A and 2B. Display terminals, not shown, are connected to the second transit server 2B. As shown, a plurality of second transit servers 2B may be connected to a first transit server 2A. The other components are the same as in the system shown in FIG. 1. Likewise, as would be appreciated by those skilled in the art, in an alternate second embodiment, a plurality of first transit servers could each be connected to a plurality of second transit servers for a more efficient and manageable delivery of a large amount of content.

For example, the first transit server 2A can be disposed in a control room of one building and the plurality of second transit servers 2B can be disposed on the individual floors of the building. In this case, the display terminals 3, for example, located in each of a plurality of offices on each of the individual floors of the building, are connected to the respective second transit servers 2B located on the respective floor of the building. Alternatively, the first transit server 2A may be disposed in a conductor's room of a tram and the second transit servers 2B may be disposed in the individual vehicles. In this case, the display terminals 3, for example, which are spaced about the interior and/or exterior of the individual vehicles, are connected to the respective second transit servers 2B.

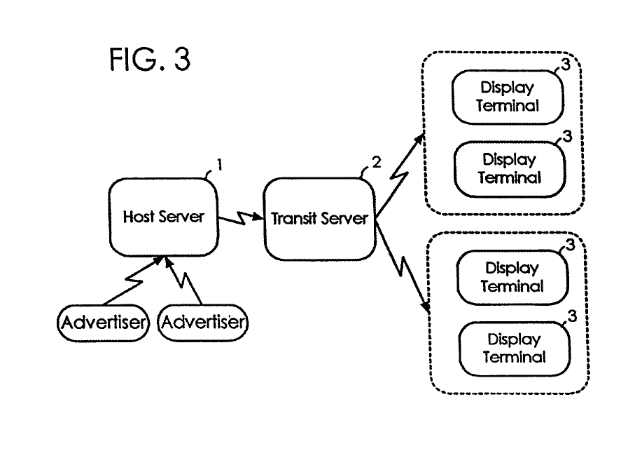

FIG. 3 shows a content delivering system according to the third embodiment, which is similar to the first embodiment but different in that the display terminals 3 of the second embodiment are divided into specified groups and the display terminals 3 belonging to each of the groups are controlled simultaneously. For example, the grouping of the display terminals 3 could be such that the display terminals 3 are divided into a group for a hanging display and to a group for a wall mounted display, all within a single vehicle. However, the two groups could instead be both for the same type of display or for displays located in different vehicles. Further, as with the second embodiment shown in FIG. 2, the third embodiment may have a two-level configuration wherein the transit server 2 comprises a first and a second transit server 2A and 2B.

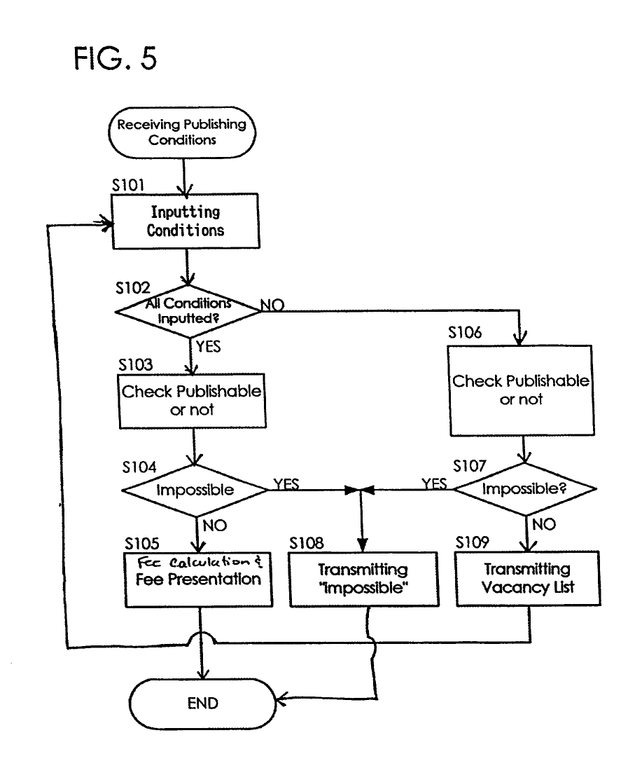

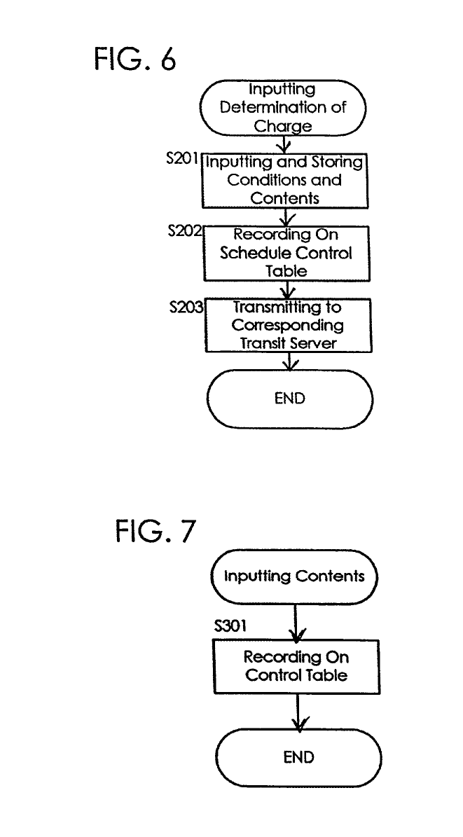

An example of processing procedures at the host server 1 will be described with reference to the flow charts shown in FIGS. 5 and 6. The processing procedure described herein assumes that each of the display terminals 3 has been provided as an advertisement in a tram. However, as will be appreciated by those skilled in the art, the processing procedures described herein would be applicable to display content on display terminals provided in other locations.

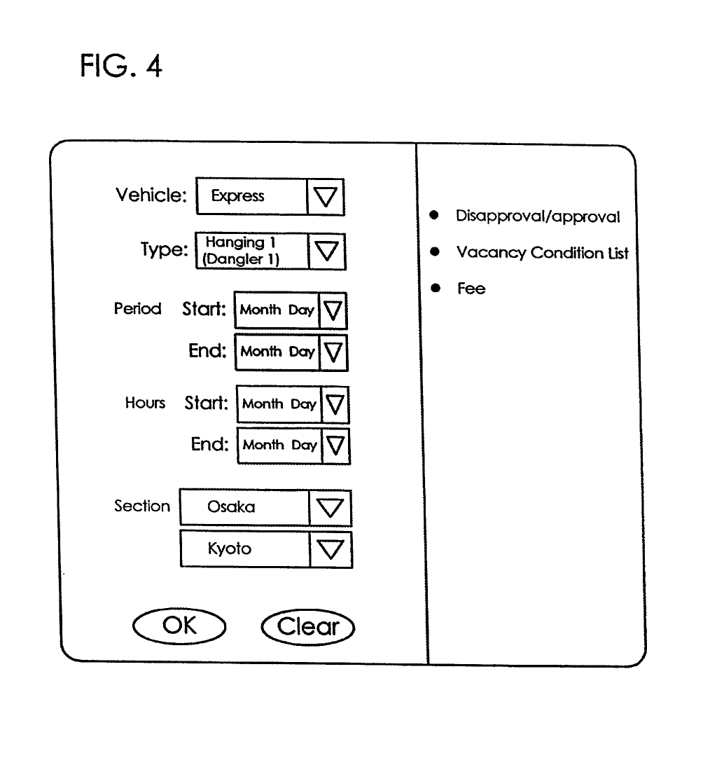

When a user (e.g., an advertiser) accesses a home page for receiving advertisements of the host server 1 via the Internet, a screen, such as the exemplary screen shown in FIG. 4, is displayed on the user's personal computer. The screen prompts the user to input desired publishing conditions for each of the advertisements the user wishes to have displayed. Upon input of the desired publishing conditions from the user, the host server 1 performs the process of receiving publishing conditions shown in FIG. 5.

When the user inputs desired publishing conditions (vehicle, type, period, etc.) on the screen and clicks “OK” displayed thereon, the desired publishing conditions are transmitted to the host server 1. The conditions may be selected from a pull-down list or menu or the like. First, the conditions are inputted to a host computer (Step S101) and it is judged whether or not all of the conditions have been inputted (Step S102). At this time, it is not necessarily required to input all the publishing conditions. If all the conditions have not been inputted (NO in Step S102), it is checked whether or not the advertisement is publishable under the inputted conditions (Step S106), while vacancy data is retrieved. Vacancy data, data on available slots or vacancies within that particular condition, is retrieved when the user does not provide input for or leaves a blank box on a condition on the publishing conditions input form on the screen. For example, if the user fails to complete a particular condition (e.g., the section data), the system reviews available options (e.g., there is no vacancy in the Osaka-Kyoto section (FIG. 4) but there is a vacancy in the Osaka-Kobe section). The retrieved vacancy data is transmitted and displayed so that the user can make the necessary decisions for that condition or modify previously selected conditions based upon the vacancy data.

If there are no vacancies for the non-selected condition, it is judged that the publishing is “impossible” (Step S107) and a statement that publishing is impossible is transmitted to the user (Step S108). If there is a vacancy or vacancies, the vacancy data is retrieved and transmitted to the user (Step S109) such that the user can view it in some manner, e.g., as a printout or as a list on the screen, while completing the pull down list of the publishing conditions. After the process is performed in Step S109, if the user fills in the condition form with reference to the vacancy list and transmits again the desired publishing conditions, the foregoing process starting in Step S101 is performed.

When all the conditions have been inputted (YES in Step S102), it is checked whether or not the advertisement is publishable (Step S103) and, if publishing is impossible, the statement that publishing is impossible is transmitted to the user (YES in Step S104, Step S108). If publishing is permissible, the charge for publishing the advertisement under the publishing conditions is calculated and transmitted to the user (Step S105). It is to be noted that the publishing charge is determined based on a combination of the publishing conditions. Moreover, the basic charge differs depending on, e.g., the estimated number of passengers in some sections. It is also possible to determine the estimated number of passengers by counting the hours during which commutation passes and tickets were used at automated ticket gates, input the obtained data to the host server 1, and update the basic charge every specified hour. If the user gives an OK to the transmitted charge, “Charge Determined” displayed on the screen (not shown in FIG. 4) is clicked. The click signal is sent to the host server 1 and the content and the publishing conditions therefor are also transmitted to the host server 1 simultaneously. It is further possible that a determination of a desired destination display terminal or group of display terminals may be selected based on the estimated number of passengers for a particular route for a particular combination of display conditions.

Upon receipt of “Charge Determined”, the host server 1 performs the process of inputting the determination of the charge shown in FIG. 6. First, the publishing conditions and the content are inputted to the host computer such that they are stored therein (Step S201) and the publishing conditions are recorded on a schedule control table (Step S202). The recorded data is used for the judgments made in Steps S103, S 106 shown in FIG. 5. Next, the content and the publishing conditions therefor are transmitted to the corresponding transit server 2 based on the publishing conditions. For example, the corresponding transit server 2 is determined based on the conditions including the type of a vehicle and a section such that the content and the publishing conditions therefor are transmitted to the corresponding transit server 2 (Step S203).

The following Table 1 shows an example of the publishing conditions.

TABLE 1

| | Publishing Conditions | | | | |
|---|---|---|---|---|---|
| | | Display | | | |
| | | Terminal | | | |
| | Vehicle | (Group) | Period | Hours | Section |
| Content A | Express | Hanging 1 | 4.1-4.15.200 | 8:00-10:00 | Osaka- |
| | | | | | Kyoto |
| Content B | Local | Wall 2 | | | |
| Content C | Express | Wall 1 | | | |

It is to be noted that the host server 1 can perform various processes other than the aforementioned process or modifications thereof. For example, it is also possible to accumulate the contents to be published on a month-by-month basis and collectively transmit the contents to be published in the next month to the corresponding server 2 in Step S203.

The schedule control table may also be stored in each of the transit servers 2. In this case, the host server 1 inquires to each of the transit servers 2 about whether the advertisement is publishable under the publishing conditions transmitted from the user. Even if a plurality of servers for receiving advertisements are installed, advertisement requests can be received properly provided that such a process is performed.

The host server 1 may also add the ID of the corresponding transit server 2 to the content and transmit the content with the ID to each of the transit servers 2. In this case, it is sufficient for the transit server 2 to selectively receive the one of the transmitted contents having the ID of its own added thereto. This saves the procedure in which the host server 1 preliminarily selects the corresponding transit server 2 and transmits.

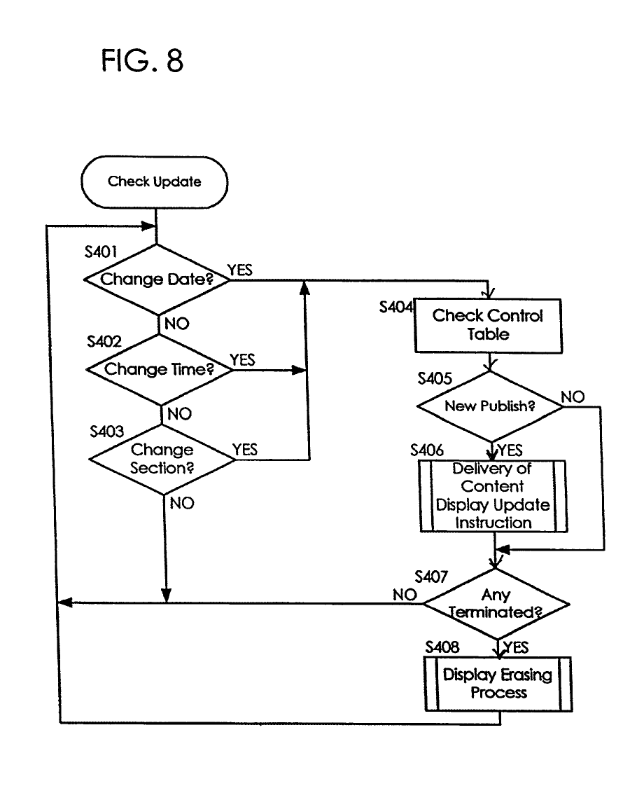

Next, an example of the processing procedure performed at the transit servers 2 will be described with reference to the flow charts shown in FIGS. 7 and 8.

If the contents and the publishing conditions are transmitted from the host server 1 to the transit servers 2, each of the transit servers 2 records the transmitted contents and publishing conditions on a control table (Step S301). Then, the transit server 2 checks an update in the displayed contents. Specifically, the transit server 2 judges whether or not a date has changed (Step S401), a time has changed (Step S402), and/or a section has changed (Step S403). If there is any change, the transit server 2 checks the control table (Step S404).

In Step S404, the contents in combinations of “Date”, “Time”, and “Section” are retrieved in the control table so that the content which satisfies the conditions for initiating the publishing is extracted. At the same time, that one of the contents already published for which publishing should be terminated is extracted. If there is any content for which publishing is to be newly initiated (YES in Step S405), the content is delivered to the corresponding display terminal 3 and an instruction to update the display is given (Step S406). If there is any content for which publishing should be terminated (YES in Step S407), an instruction to erase the content displayed is given to the corresponding display terminal 3 (Step S408).

The delivery of the content from the transmit server 2 to the display terminals 3 is performed simultaneously to each of the display terminals 3. Although it is possible to selectively and sequentially deliver the content to the specified display terminals to which the content should be delivered, simultaneous delivery is preferred in terms of saving communication time. A wireless LAN may also be used.

If the content is delivered simultaneously from the transit server 2 to the display terminals 3, the following two systems can be listed as typical communication systems. The first communication system is used in the case where each of the display terminals 3 recognizes the group to which it belongs. The second communication system described is used in the case where each of the display terminals 3 has an ID of its own.

For example, when each of the display terminals 3 recognizes the group to which it belongs, the content to be newly published has the name of a terminal group added thereto, such as “Hanging 1” or “Wall 1” on which the content should be displayed, as shown in the following Table 2. If the name of the group which has been added to the delivered content matches the group to which the display terminal 3 belongs, the content is stored and displayed.

TABLE 2

| Content to be Newly Published | Terminal Group |
|---|---|
| A | Hanging 1 |
| B | Wall 1 |

Where each of the display terminals 3 has an ID of its own, the name of the terminal group is converted to the IDs of the terminals belonging to the group, which are added to the content. However, the name of the terminal group is not additional data. For example, as shown in the following Tables 3 and 4, a content to be newly published has the IDs of the terminals on which it should be displayed, and if the terminal ID added to the delivered content is that of the display terminal 3, the content is stored and displayed thereon. Table 3 shows an example in which the terminal IDs are added to the contents in a one-to-one relationship. Table 4 shows an example in which a plurality of terminal IDs are added to each of the contents. This example is efficient since the content is transmitted simultaneously to the plurality of display terminals in one delivery.

TABLE 3

| Content to be Newly | | |
|---|---|---|
| Published | Terminal ID | (Terminal Group) |
| A | IDa | (Hanging 1) |
| A | IDb | |
| A | IDc | |
| B | IDe | (Wall 1) |
| B | IDf | |

TABLE 4

| Content to be Newly | | |
|---|---|---|
| Published | Terminal ID | (Terminal Group) |
| A | IDa | (Hanging 1) |
| | IDb | |
| | IDc | |
| B | IDe | (Wall 1) |
| | IDf | |

If the transit server 2 transmits “Content to be Erased” instead of “Content to be Newly Published,” the display terminals 3 erase the content currently displayed based on the name of the terminal group or on the terminal IDs.

In the communication systems described above, the contents are delivered from the transit server 2 to each of the display terminals 3 after the publishing conditions are satisfied. If the communication speed is low or the content has a large amount of data, however, the communication requires time and the timing for initiating display may be delayed.

To solve the time requirement problem, it is possible to deliver the content to be displayed subsequently to each of the display terminals 3 during the period other than timings for changing updating conditions and transmit only an update instruction signal with a timing for changing updating conditions. If the contents delivered in advance are stored in an internal non-volatile memory of each of the display terminals, the contents can be brought into a standby state even if the power is turned off. It is also possible to expect the time required to deliver the content and deliver the content to the display terminal 3 in advance.

The grouping of the display terminals described above in association with the communication systems can be performed in various embodiments other than those shown in Tables 3 and 4. For example, the grouping may be performed according to the order in which the display terminals are installed, e.g., according to whether they are odd-numbered or even-numbered display terminals in the order of installation. If the display terminals 3 are installed in a building, they can be grouped on a floor-by-floor basis or according to the place where they are installed, such as the main entrance, hallways, or individual offices.

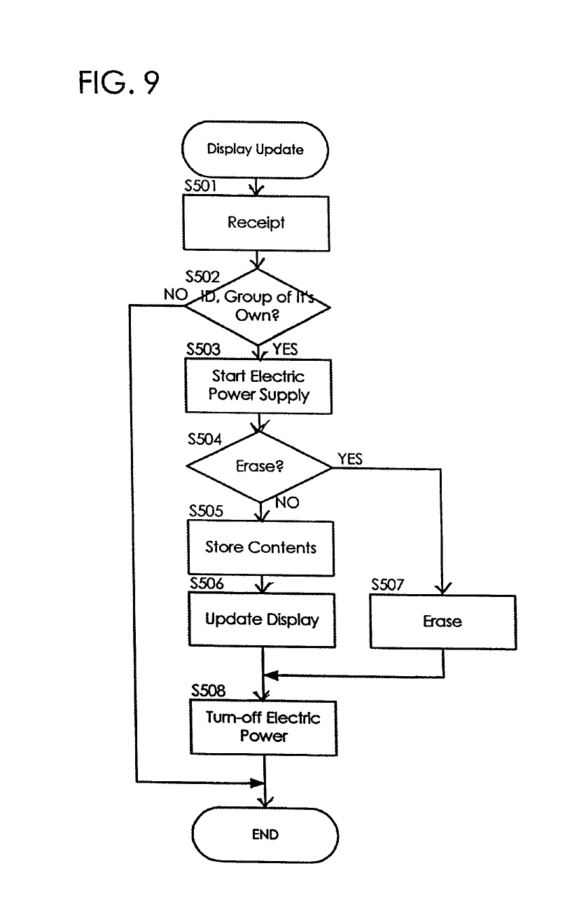

Referring now to the flow chart shown in FIG. 9, an example of the processing procedure performed at the display terminals 3 will be described. It is assumed that a display element containing a liquid crystal showing a cholesteric phase, such as a chiral nematic liquid crystal, is used as the display terminal 3. Since the liquid crystal showing the cholesteric phase has a memory property, the supply of electric power is halted once display is effected, whereby the effect of energy conservation is achieved.

Upon receipt of the content and the name of the terminal group or the terminal ID (Step S501), the display terminal 3 judges whether or not the name of the terminal group or terminal ID received is of its own (Step S502). If the name of the terminal group or terminal ID is that of the display terminal 3, the supply of electric power for performing a display updating operation to each of the components is initiated (Step S503).

If an erase instruction has been given (YES in Step S504), the content currently displayed is erased (Step S507) and the power is turned off (Step S508). If the erase instruction has not been given (NO in Step S504), the received content is stored in the memory (Step S505) and the display is updated (Step S506). Thereafter, the power is turned off(Step S508).

This disclosure is based on Application No. JP 00-0084186 filed in Japan, the content of which is hereby incorporated by reference in its entirety.

It is to be noted that the content delivering system according to the present invention is not limited to the foregoing embodiments. Various changes and modifications can be made within the scope of the present invention by those who are skilled in the art. In particular, the transit servers and the display terminals can be combined arbitrarily. The places at which they are installed can be determined arbitrarily and the display terminals can be grouped arbitrarily. Further, the contents to be displayed need not necessarily be limited to advertisements.

What is claimed is:

1. A content delivering system comprising:
a host server for receiving a plurality of inputs, such inputs respectively including associated display conditions;
a display terminal for displaying at least one of said plurality of inputs in accordance with said associated display conditions; and
a transit server for receiving said plurality of input, storing said plurality of input, and timely distributing at least one of said plurality of inputs to said display terminal.

2. A content delivering system according to claim 1, wherein said host server is adapted to calculate a fee for display of each of said plurality of input, and
wherein said fee is calculated based on said associated display conditions.

3. A content delivering system according to claim 1, wherein said host server is adapted to calculate a fee for display of each of said plurality of inputs, and
wherein said fee is calculated based on a potential viewer population.

4. A content delivering system according to claim 1, wherein said transit server is adapted to deliver the at least one input to said display terminal in advance of display of the at least one input, and such input(s) are stored therein until displayed.

5. A content delivering system according to claim 1, wherein when display conditions require deletion of a certain input that is subject to display, said transit server is adapted to issue an erase command to an appropriate display terminal, to effect removal of such input from said display terminal.

6. A content delivering system according to claim 1, wherein said display terminal has a chiral nematic liquid crystal display having a cholesteric phase.

7. A content delivering system comprising:
a host server for receiving a plurality of inputs, such input respectively including associated display conditions;
a plurality of display terminals for displaying at least one of said plurality of input in accordance with said associated display conditions; and
a plurality of transit servers for receiving ones of said plurality of input, storing said ones of said plurality of input, and timely distributing one of said plurality of input to at least one of said plurality of display terminals,
wherein said associated display conditions include certain data that defines at least one of said plurality of display terminals to receive related inputs at said plurality of inputs for display, and
wherein said associated display conditions include certain data that defines at least one of said plurality of display terminals to receive related input(s) of said plurality of inputs for display.

8. A content delivering system according to claim 7, wherein said plurality of transit servers includes a pair of transit servers, coupled in series, between said host server and at least one of said plurality of display terminals.

9. A content delivering system according to claim 7,
wherein said plurality of display terminals are divided into a plurality of groups, and
wherein each of said plurality of transit servers is adapted to deliver input to one group of said plurality of groups, and such input is displayable at a prescribed time on each display terminal of such group.

10. A content delivering system according to claim 9, wherein said display conditions associated with each of said inputs include a display terminal ID, said display terminal ID corresponding to one of a particular display terminal within a related group of display terminals.

11. A content delivering system according to claim 9,
wherein one of said plurality of transit servers serves as a first level transit server, and
wherein others of said plurality of transit servers serve as second level transit servers, each second level transit server having a corresponding group of display terminals, said plurality of second level transit servers receiving are adapted to receive input and associated display conditions from said first level transit server for delivery to and display on their respective corresponding group of display terminals.

12. A content delivering system according to claim 11, wherein each second level transit server is adapted to select at least one display terminal of its corresponding group of display terminals based on corresponding display conditions and distribute said input to the at least one display terminal.

13. A content delivering system according to claim 7, wherein said host server is adapted to indicate a fee to display the input and wherein said fee is calculated based on the corresponding display conditions.

14. A content delivering system according to claim 7,
wherein said host server is adapted to calculate a fee for display of each of said plurality of inputs, and
wherein said fee is calculated based on a potential viewer population.

15. A content delivering system comprising:
a host server for receiving a plurality of inputs, such input respectively including associated display conditions;
a plurality of display terminals for displaying input(s) in accordance with said associated display conditions; and
a plurality of transit servers for receiving at least one input, storing said at least one input, and distributing at least one input to an appropriate one of said plurality of display terminals.

16. A content delivering system according to claim 15, wherein said host server is adapted to indicate a fee to display the input and wherein said fee is calculated based on the corresponding display conditions.

17. A content delivering system according to claim 16, wherein said host server is adapted to calculate a fee for display of each of said plurality of inputs, and
wherein said fee is calculated based on a potential viewer population.

18. A transit server for a content delivering system, said content delivering system including a host server and a plurality of display terminals, said display terminals being organized into a plurality of display terminal groups, said transit server comprising:
receiving means for receiving input and display conditions corresponding to said input from the host server; and
a determining means for determining from said display conditions an appropriate display terminal group destination for said corresponding input.

19. A transit server according to claim 18, wherein each of said plurality of display terminal groups includes at least two display terminals and wherein said transit server is adapted to distribute to each display terminal in such group.

20. A transit server according to claim 18, wherein said determining means is further adapted to determine a particular one of said display terminals of said appropriate display terminal group

21. A transit server according to claim 19, wherein said determining means is adapted to determine appropriate handling of any currently displayed input prior to delivery of said input to the appropriate display terminal.

22. A transit server according to claim 18,
wherein said transit server has a first level and a second level; and
wherein said second level is coupled to said first level and is coupled to the plurality of display terminal groups, said second level being adapted to receive input and display conditions from said first level for delivery to at least one group of the plurality of display terminal groups.

23. A method of using a host server and at least one transit server to direct the display and routing of input content to display terminals based on display conditions corresponding to the input content, the method comprising the steps of:
transmitting input content and display conditions from the host server to the at least one transit server;
determining if all necessary display conditions have been received;
when all necessary display conditions have been received, determining whether or not the content is displayable based on the display conditions,
when said content is displayable, determining an appropriate display terminal destination based at least in part on said display conditions, and
calculating and transmitting charge data to the user; and
when said content is displayable, timely transmitting said input content and said display conditions from the at least one transit server to said appropriate display terminal for display according to said display conditions.

24. A method according to claim 23, further comprising the steps of:
when less than all necessary display conditions have been received, retrieving vacancy data for a missing necessary display condition; and
transmitting said vacancy data to a user for use in determining an input for said missing necessary display condition.

25. A method according to claim 23 further comprising the step of:
when said content is not displayable, transmitting a message to the host server which indicates a non-display state to the user.

26. A method according to claim 23, wherein the step of calculating said charge data includes determining said charge data based at least in part on display terminal ID information transmitted with the display information.

27. A method according to claim 23, wherein the step of calculating said charge data includes determining said charge data based at least in part on potential view population data.

28. A method according to claim 23, the step of calculating said charge data includes the step of determining said charge data based at least in part on said display conditions, the appropriate display terminal destination, and potential viewer population data.

29. A computer readable medium having a memory system and a program stored thereon, the program implementing a method of using a host server and at least one transit server to direct the display and routing of input content to display terminals based on display conditions corresponding to the input content, the method comprising the steps of:
transmitting input content and display conditions from the host server to the at least one transit server;
determining if all necessary display conditions have been received;
when all necessary display conditions have been received, the at least one transit server determining whether or not the content is displayable based on the display conditions,
when said content is displayable, determining an appropriate display terminal destination based at least in part on said display conditions, and
calculating and transmitting charge data to the user; and
when said content is displayable, timely transmitting said input content and said display conditions from the at least one transit server to said appropriate display terminal for display according to said display conditions.

30. An internet-based interactive facility utilizing a computer readable medium having a memory system and a program stored thereon, the program implementing a method of using a host server and at least one transit server to direct the display and routing of input content to display terminals based on display conditions corresponding to the input content, the method comprising the steps of:
transmitting input content and display conditions from the host server to the at least one transit server;
determining if all necessary display conditions have been received;
when all necessary display conditions have been received, the at least one transit server determining whether or not the content is displayable based on the display conditions,
when said content is displayable, determining an appropriate display terminal destination based at least in part on said display conditions, and
calculating and transmitting charge data to the user; and
when said content is displayable, timely transmitting said input content and said display conditions from the at least one transit server to said appropriate display terminal for display according to said display conditions.
